(19) United States
(12) Patent Application Publication
(10) Pub. No.: US 2025/0124280 A1
(43) Pub. Date: Apr. 17, 2025

(54) METHOD AND APPARATUS FOR APPROXIMATING NONLINEAR FUNCTION

(71) Applicant: SAMSUNG ELECTRONICS CO., LTD., Suwon-si (KR)

(72) Inventor: Soobok YEO, Suwon-si (KR)

(73) Assignee: SAMSUNG ELECTRONICS CO., LTD, Suwon-si (KR)

(21) Appl. No.: 18/917,274

(22) Filed: Oct. 16, 2024

(30) Foreign Application Priority Data
Oct. 17, 2023 (KR) 10-2023-0138858

(51) Int. Cl. G06N 3/08; G06N 3/047

(52) U.S. Cl. CPC G06N 3/08; G06N 3/047

(57) ABSTRACT

A method of approximating a nonlinear function in units of a plurality of segments is provided and includes: detecting an input included in a shortest segment among the plurality of segments; shifting the nonlinear function such that the input is zero in a floating point format; defining the plurality of segments based on at least one bit of the floating point format; and approximating the plurality of segments into a plurality of linear functions, respectively.

### CROSS-REFERENCE TO RELATED APPLICATION

This application is based on and claims priority under 35 U.S.C. § 119 to Korean Patent Application No. 10-2023-0138858, filed on Oct. 17, 2023, in the Korean Intellectual Property Office, the disclosure of which is incorporated by reference herein in its entirety.

### BACKGROUND

### 1. Technical Field

Embodiments of the present disclosure relate to implementation of a nonlinear function, and more particularly, to a method and an apparatus for approximating a nonlinear function.

### 2. Brief Description of Related Art

The nonlinear function may be used in a variety of applications. For example, an artificial neural network may use a nonlinear activation function. It may not be easy to implement the nonlinear function using only simple arithmetic operations such as addition, subtraction, multiplication, etc., and accordingly, a function approximated from the nonlinear function may be used. For the performance and efficiency of the applications, it may be important to implement the nonlinear function with high accuracy as well as low cost, such as low resources and low power consumption.

### SUMMARY

Embodiments of the present disclosure provide a method and an apparatus for approximating a nonlinear function with high accuracy and low cost.

According to embodiments of the present disclosure, a method of approximating a nonlinear function in units of a plurality of segments is provided and includes: detecting an input included in a shortest segment among the plurality of segments; shifting the nonlinear function such that the input is zero in a floating point format; defining the plurality of segments based on at least one bit of the floating point format; and approximating the plurality of segments into a plurality of linear functions, respectively.

According to embodiments of the present disclosure, of generating an output of a nonlinear function approximated in units of a plurality of segments is provided and includes: generating a converted input by subtracting a constant from an input in a floating point format; identifying a segment, including the converted input, among the plurality of segments based on at least one bit of the converted input; obtaining at least one coefficient of a linear function corresponding to the segment, that is identified, from a lookup table; and calculating the output of the linear function based on the converted input and the at least one coefficient, wherein the constant corresponds to an amount by which the nonlinear function is shifted so that a shortest segment among the plurality of segments includes zero in the floating point format.

According to embodiments of the present disclosure, an apparatus for generating an output of a nonlinear function approximated in units of a plurality of segments is provided and includes: a floating point adder configured to generate a converted input by subtracting a constant from an input in a floating point format; an index generator configured to generate an index of a segment, including the converted input, among the plurality of segments based on at least one bit of the converted input; and a linear calculator configured to obtain at least one coefficient of a linear function based on the index from a lookup table and generate the output based on the input and the at least one coefficient, wherein the constant corresponds to an amount by which the nonlinear function is shifted so that a shortest segment among the plurality of segments includes zero in the floating point format.

### BRIEF DESCRIPTION OF DRAWINGS

Embodiments will be more clearly understood from the following detailed description taken in conjunction with the accompanying drawings in which:

FIG. 1 is a diagram showing approximation of a nonlinear function according to an embodiment;

FIGS. 2A and 2B are graphs showing examples of a function approximated according to some embodiments;

FIG. 3 is a diagram showing a floating point format according to an embodiment;

FIG. 4 is a graph showing segments of a nonlinear function according to an embodiment;

FIG. 5 is a flowchart of a method of approximating a nonlinear function according to an embodiment;

FIGS. 6A and 6B are flowcharts showing examples of a method of approximating a nonlinear function according to an embodiment;

FIG. 7 is a flowchart of a method of approximating a nonlinear function according to an embodiment;

FIG. 8 is a flowchart of a method of approximating a nonlinear function according to an embodiment;

FIG. 9 is a flowchart of a method of approximating a nonlinear function according to an embodiment;

FIG. 10 is a flowchart of a method of approximating a nonlinear function according to an embodiment;

FIG. 11 is a flowchart of a method of approximating a nonlinear function according to an embodiment;

FIG. 12 is a block diagram of an apparatus according to an embodiment;

FIG. 13 is a block diagram of another index generator according to an embodiment;

FIG. 14 is a diagram of a lookup table according to an embodiment;

FIG. 15 is a block diagram of a computing system according to an embodiment; and

FIG. 16 is a block diagram of a computing device according to an embodiment.

### DETAILED DESCRIPTION

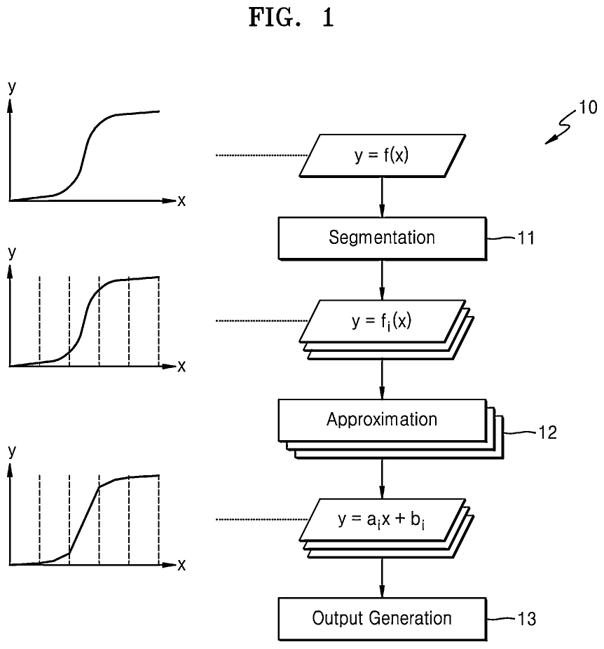

FIG. 1 is a diagram showing approximation 10 of a nonlinear function according to an embodiment. As shown in FIG. 1, the approximation 10 of a nonlinear function may include segmentation 11, approximation 12, and output generation 13. In some embodiments, the segmentation 11 and the approximation 12 may be performed in advance outside of an application using an output of the nonlinear function (i.e., offline) and the output generation 13 may be performed in the application (i.e., online).

Referring to FIG. 1, a nonlinear function f(x) may be provided. “x” and “y” may be an input and an output of a nonlinear function, respectively. The nonlinear function may be used in a variety of applications. For example, an artificial neural network may include a nonlinear activation function. For example, the artificial neural network may include the nonlinear activation function such as sigmoid, Tanh, Gaussian error linear unit (GELU), sigmoid linear unit (SiLU), etc. The artificial neural network may generate massive outputs of the activation function, and thus, the performance and efficiency of the artificial neural network may greatly depend on the accuracy and cost of the activation function. It may not be easy to implement a nonlinear function using only simple arithmetic operations provided by hardware, such as addition, subtraction, and multiplication, and thus, the output of the approximated function may be used in applications.

As described below with reference to the drawings, the nonlinear function may be easily approximated in units of non-uniform segments, and thus, the approximated function may have high accuracy. Additionally, the nonlinear function may be easily approximated based on a data format provided by hardware, for example, a floating point format, and thus, the approximated function may be realized with a simple structure. Additionally, adjustable approximation parameters may be provided according to requirements, and thus, the approximated function optimal for the application may be generated.

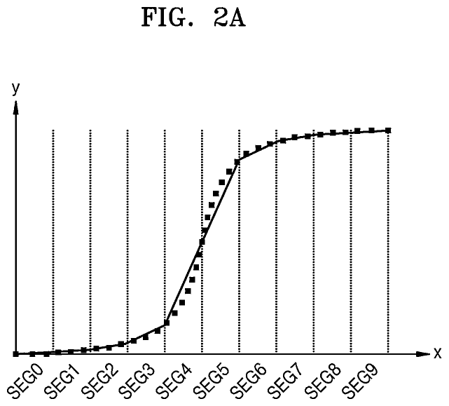

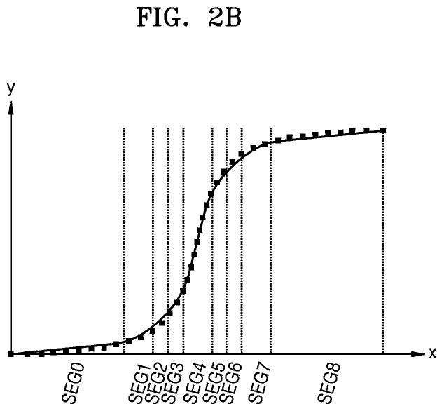

The segmentation 11 may be performed on the nonlinear function f(x). As described above, it may not be easy to approximate the nonlinear function f(x) using only arithmetic operations, and accordingly, a plurality of segments resulting from segmenting the nonlinear function f(x) may be approximated independently of each other. As described below with reference to FIGS. 2A and 2B, the nonlinear function f(x) may be approximated with higher accuracy (or lower error) when segmented into non-uniform segments than when segmented into uniform segments. As shown in FIG. 1, when variable i is an index of a segment, the segmentation 11 may be performed on the nonlinear function f(x) to generate N segments fᵢ(x)(1≤i≤N).

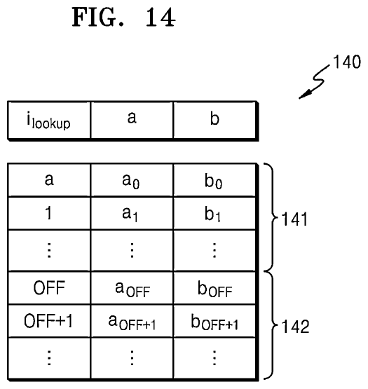

The approximation 12 may be performed for N segments fᵢ(x)(1≤i≤N). For example, the segment fᵢ(x) of the nonlinear function may be approximated into a linear function aix+b; that minimizes an approximation error based on least squares. Accordingly, as shown in FIG. 1, N linear functions aix+bᵢ (1≤i≤N) may be generated, and the linear function aᵢx+bᵢ may be defined by coefficients ai and bi. Accordingly, the approximated function may be defined by ranges of segments and coefficients of linear functions. In some embodiments, as described below with reference to FIG. 14 and elsewhere, the approximated function may be defined by a lookup table including segment indices and coefficients.

The output generation 13 may be performed based on the approximated function. For example, among N segments, a segment including input x of the approximated function may be identified, and an output of the approximated function may be generated based on coefficients corresponding to the input x and the identified segment. As described below with reference to the drawings, the input x of the approximated function may have a floating point format, and the segment including the input x may be easily identified due to the floating point format. Accordingly, the output generation 13 may be performed at high speed, and resources for the output generation 13 may be reduced. As a result, the performance and efficiency of applications using the nonlinear function may be enhanced.

FIGS. 2A and 2B are graphs showing examples of a function approximated according to some embodiments. For example, the graphs of FIGS. 2A and 2B represent functions approximated by differently segmenting the same nonlinear function. In FIGS. 2A and 2B, a bold dotted line represents the nonlinear function, and a solid line represents the approximated function.

Referring to FIG. 2A, the nonlinear function f(x) may be segmented into 10 uniform segments SEG0 to SEG9. That is, the 10 segments SEG0 to SEG9 may have the same length, that is, the input range. As shown in FIG. 2A, each of the 10 segments SEG0 to SEG9 may be approximated into a linear function.

Referring to FIG. 2B, the nonlinear function f(x) may be segmented into 9 non-uniform segments SEG0 to SEG8. That is, each of the nine segments SEG0 to SEG8 may have a unique length, that is, the input range. For example, as shown in FIG. 2B, short segments (e.g., segments SEG2, SEG3, SEG5, and SEG6) may be placed densely in areas where the gradient of the nonlinear function changes rapidly, while long segments (e.g., segments SEG0 and SEG8) may be placed in areas where the gradient of the nonlinear function is substantially flat. Accordingly, although the approximated function of FIG. 2B has 9 segments SEG0 to SEG8, which are fewer than the 10 segments SEG0 to SEG9 of FIG. 2A, the approximated function of FIG. 2B has a lower error rate than an error rate of FIG. 2A. As described below with reference to the drawings, non-uniform segments, which have an advantage over uniform segments, may be easily defined and indexed using the floating point format.

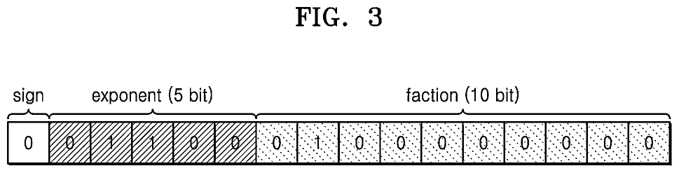

FIG. 3 is a diagram showing a floating point format according to an embodiment. For example, FIG. 3 shows FP16 (or half precision floating point format) as an example of the floating point format. The hardware may support at least one floating point format, may operate on numbers in floating point format, and may generate numbers in floating point format as an operation result.

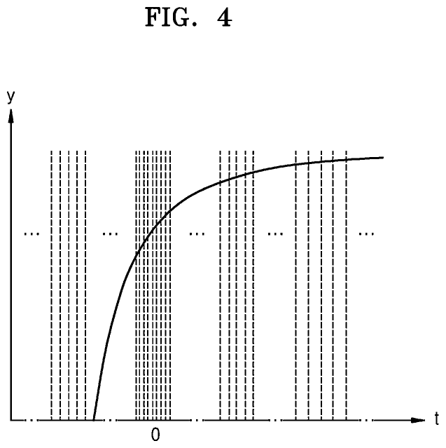

Referring to FIG. 3, FP16 may consist of 16-bits, and 16-bits may include the most significant bit (MSB) representing a sign, 5-bits representing an exponent, and 10-bits representing a fraction. In the floating point format, the resolution expressed as a number may vary depending on a value of the exponent. For example, the difference between adjacent numbers may be the same at the same value of the exponent, while the difference between adjacent numbers may decrease as the value of the exponent becomes less. For example, FP16 may have a resolution of 2⁻²⁴ at the exponent between 2⁻²⁴ and 2⁻¹³, while FP16 may have a resolution of 2⁽ⁿ⁻¹⁰⁾ at the exponent between 2ⁿ and 2ⁿ⁺¹ (−13≤n≤15). As described below with reference to FIG. 4, the floating point format of which resolution varies depending on the exponent may be used to define and index non-uniform segments of the nonlinear function. Hereinafter, FP16 is mainly described, but embodiments are not limited to the FP16 of FIG. 3. For example, arbitrary floating point formats such as FP32 (or single precision floating point format), bfloat16 (or brain floating point format), and the like may also be applied.

FIG. 4 is a graph showing segments of a nonlinear function according to an embodiment. For example, the graph of FIG. 4 shows segments resulting from segmenting a nonlinear function based on the floating point format.

As described above with reference to FIG. 3, the floating point format may have a higher resolution as the exponent becomes less, and may have a lower resolution as the exponent becomes greater. Accordingly, a range where a high resolution is required in the nonlinear function, that is, a range where short segments are densely located, may correspond to a small exponential range in floating point format with a high resolution, and a range where a low resolution is required in the nonlinear function, that is, a range where long segments are located, may correspond to a large exponential range in floating point format with a low resolution.

The nonlinear function may be shifted to match the range where short segments are densely located with the small exponential range. For example, as shown in FIG. 4, the floating point format may have a highest resolution at zero, and the nonlinear function may be shifted so that a shortest segment includes zero. When the nonlinear function f(x) is shifted by the constant x_{c}, the shifted function f(t) may be expressed as in Equation 1 below.

$$f ( t ) = f ( x - {x}_{c} ) \qquad [ Equation 1 ]$$

Herein, input t of the shifted nonlinear function f(t) may be referred to as an input converted from the input x of the nonlinear function f(x).

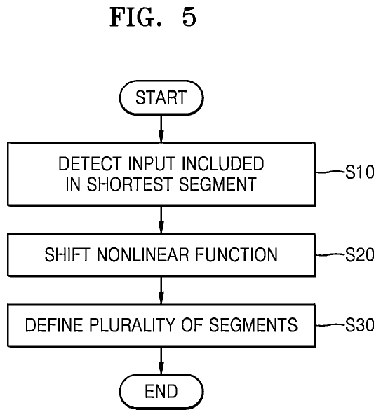

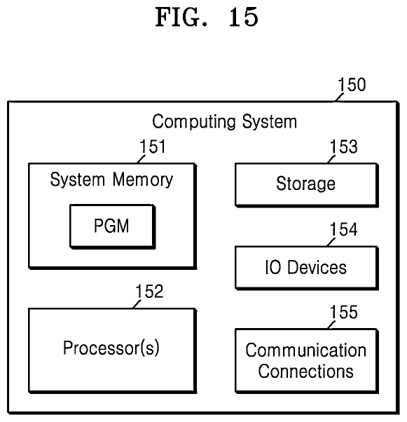

FIG. 5 is a flowchart of a method of approximating a nonlinear function according to an embodiment. For example, the flowchart of FIG. 5 may represent an operation corresponding to the segmentation 11 of FIG. 1, and the method of FIG. 5 may be referred to as a method of approximating the nonlinear function in units of a plurality of segments. As described above with reference to FIG. 1, the method of FIG. 5 may be performed offline in advance. In some embodiments, the method of FIG. 5 may be performed by a computing system (e.g., computing system 150 of FIG. 15). As shown in FIG. 5, the method of approximating a nonlinear function in units of a plurality of segments may include a plurality of operations (e.g., operation S10, operation S20, and operation S30).

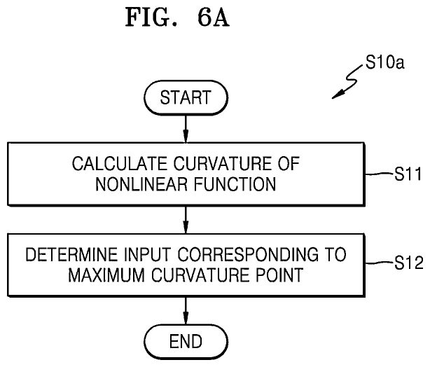

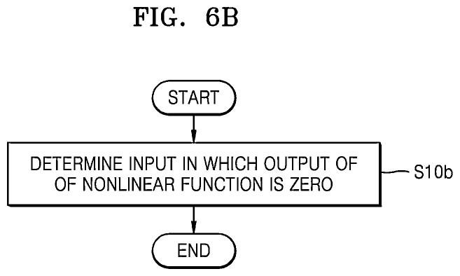

Referring to FIG. 5, the input included in the shortest segment may be detected in operation S10. As described above with reference to FIG. 4, the nonlinear function may be segmented into non-uniform segments, and the nonlinear function may be shifted such that the shortest segment among the segments corresponds to zero in floating point format. To identify the shift amount of the nonlinear function, the input of the nonlinear function included in the shortest segment (e.g., the constant x_{c} in Equation 1) may be detected. Examples of operation S10 are described below with reference to FIGS. 6A and 6B.

In operation S20, the nonlinear function may be shifted. For example, the nonlinear function may be shifted such that the input detected in operation S10 is zero. Accordingly, the shifted nonlinear function may be segmented into short segments in a range including the input which is zero.

In operation S30, a plurality of segments may be defined. As described above with reference to FIG. 3, the floating point format may have a resolution that varies depending on the exponent, and accordingly, the range of each of the plurality of segments may be defined based on at least one bit in floating point format. The input t converted from input x of the nonlinear function f(x) may have a floating point format, and bits of the input t may be defined as tᵢₙₜ. For example, when the input t is 1.0 of FP16, tᵢₙₜ may be hexadecimal 3C00 (or 0×3C00). The tᵢₙₜ may be considered an integer type, and may be arithmetic. For example, tᵢₙₜ+0×1=0×3C01.

The plurality of segments may be defined by an offset iₒ and a shift amount sh, and operation S30 may include obtaining the offset iₒ and the shift amount sh. For example, index i of the segment may be defined as in Equation 2 below.

$$i = ( {t}_{int} - {i}_{o} ) ≫ sh \qquad [ Equation 2 ]$$

That is, to generate index i of the segment, a value generated by subtracting the offset iₒ from the converted input t and then the generated value is right-shifted by the shift amount sh. Accordingly, the length of each of the segments and the number of the segments may be adjusted by the offset i, and the shift amount sh. For example, as the offset iₒ or the shift amount sh increases, the length of each of the segments may be extended while the number of segments may be decreased. Accordingly, the offset iₒ and the shift amount sh may be adjusted according to requirements as approximation parameters, and the nonlinear function may be approximated optimally for the application.

In some embodiments, the index calculated in Equation 2 may be clipped. For example, the index i of the segment may be defined as in Equation 3 below.

$$i = max ( ( {t}_{int} - {i}_{o} ) ≫ sh , 0 ) \qquad [ Equation 3 ]$$

That is, when a value generated by subtracting the offset iₒ from the converted input t and then right-shifting by the shift amount sh is a negative number, the index i may be zero.

FIGS. 6A and 6B are flowcharts showing examples of a method of approximating a nonlinear function according to an embodiment. For example, the flowcharts of FIGS. 6A and 6B show examples of operation S10 of FIG. 5. As described above with reference to FIG. 5, the input included in the shortest segment of the nonlinear function may be detected in operation S10a of FIG. 6A and operation S10b of FIG. 6B.

Referring to FIG. 6A, operation S10a may include operation S11 and operation S12. In operation S11, a curvature of the nonlinear function may be calculated. As described above with reference to FIGS. 2A and 2B, when the nonlinear function is approximated into linear functions, it may be advantageous to place short segments in a range where the gradient of the nonlinear function changes rapidly. Accordingly, the curvature of the nonlinear function may be calculated.

The curvature of a function may be calculated as the reciprocal of the radius of the osculating circle at a point on the curve of the function. For example, curvature k of the nonlinear function f(x) may be calculated as in Equation 4 below.

$$k = \frac{{f}^{″} ( x )}{{( 1 + {{f}^{′} ( x )}^{2} )}^{3 / 2}} \qquad [ Equation 4 ]$$

In operation S12, an input corresponding to a maximum curvature point may be determined. In the nonlinear function, the maximum curvature point may refer to a point where the gradient changes most sharply, and the input corresponding to the maximum curvature point may be determined accordingly. As described above with reference to FIG. 5, the nonlinear function may be shifted so that the determined input is zero in floating point format.

Referring to FIG. 6B, in operation S10b, an input in which the output of the nonlinear function is zero may be determined. Unlike operation S10a of FIG. 6A, which utilizes the curvature of the nonlinear function to minimize the arithmetic mean approximation error, operation S10b of FIG. 6B may detect an input to minimize the error in floating-point numbers. That is, since the output of the nonlinear function is also expressed in floating point format, to minimize the error in the floating-point numbers from the perspective of the unit in the last place (ULP), the input in which the output of the nonlinear function is zero may be determined.

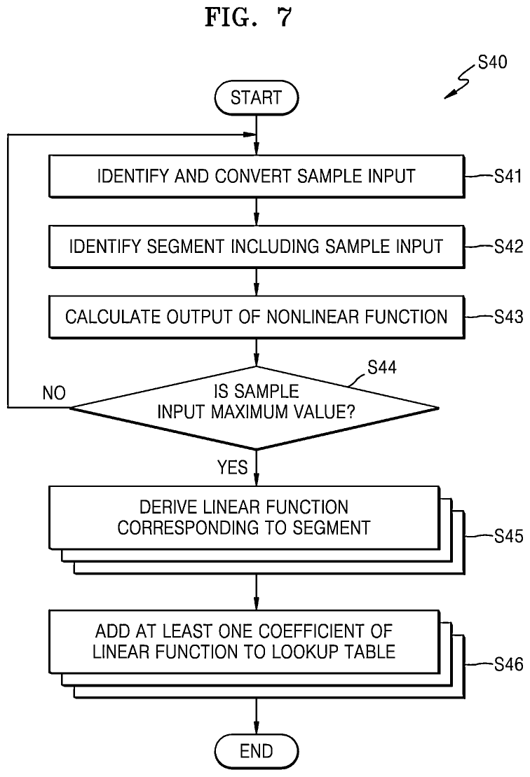

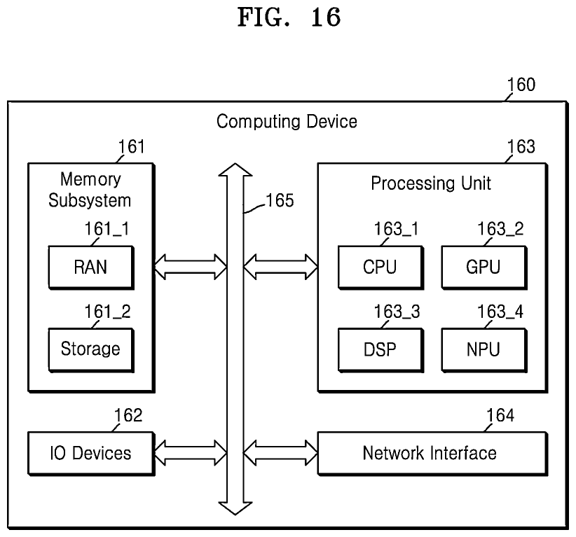

FIG. 7 is a flowchart of a method of approximating a nonlinear function according to an embodiment. For example, the flowchart of FIG. 7 may represent an operation corresponding to the approximation 12 of FIG. 1, and the method of FIG. 7 may be referred to as a method of approximating a nonlinear function in units of a plurality of segments. As described above with reference to FIG. 1, operation S40 of FIG. 7 may be previously performed offline following operation S30 of FIG. 5. In some embodiments, operation S40 of FIG. 7 may be performed by a computing device (e.g., computing device 160 of FIG. 16). As shown in FIG. 7, operation S40 may include a plurality of operations S41 to S46. As shown in FIG. 7, operations S41 to S44 may be performed repeatedly, and each of operations S45 and S46 may include a plurality of parallel operations.

In some embodiments, a segment of a nonlinear function may be approximated into a linear function based on least squares. For example, linear function aᵢx+bᵢ to which segment fᵢ(x) of the linear function f(x) is approximated may be expressed as in a linear equation of Equation 5 below.

$$[ \begin{matrix}{x}_{0} & 1 \\ {x}_{1} & 1 \\ ⋮ & ⋮ \\ {x}_{M - 1} & 1\end{matrix} ] [ \begin{matrix}{a}_{i} \\ {b}_{i}\end{matrix} ] = [ \begin{matrix}f ( {x}_{0} ) \\ f ( {x}_{1} ) \\ ⋮ \\ f ( {x}_{M - 1} )\end{matrix} ] \qquad [ Equation 5 ]$$

“M” which is a positive integer may be the number of sample inputs included in the segment fᵢ(x). Using pseudo inverse, coefficients aj and bi may be calculated as shown in Equation 6 below.

$$[ \begin{matrix}{a}_{i} \\ {b}_{i}\end{matrix} ] = {{( {[ \begin{matrix}{x}_{0} & 1 \\ {x}_{1} & 1 \\ ⋮ & ⋮ \\ {x}_{M - 1} & 1\end{matrix} ]}^{T} [ \begin{matrix}{x}_{0} & 1 \\ {x}_{1} & 1 \\ ⋮ & ⋮ \\ {x}_{M - 1} & 1\end{matrix} ] )}^{- 1} [ \begin{matrix}{x}_{0} & 1 \\ {x}_{1} & 1 \\ ⋮ & ⋮ \\ {x}_{M - 1} & 1\end{matrix} ]}^{T} [ \begin{matrix}f ( {x}_{0} ) \\ f ( {x}_{1} ) \\ ⋮ \\ f ( {x}_{M - 1} )\end{matrix} ] = \frac{1}{Mq - {p}^{2}} [ \begin{matrix}Ms - p \cdot r \\ q \cdot r - p \cdot s\end{matrix} ] where p = {\sum }_{m = 0}^{M - 1} {x}_{m} , q = {\sum }_{m = 0}^{M - 1} {x}_{m}^{2} , r = {\sum }_{m = 0}^{M - 1} f ( {x}_{m} ) , and s = {\sum }_{m = 0}^{M - 1} {x}_{m} f ( {x}_{m} ) \qquad [ Equation 6 ]$$

When M sample inputs are given in a segment of the nonlinear function, coefficients of the linear function may be calculated by Equation 5 and Equation 6, and the linear function may be derived.

Referring to FIG. 7, the sample input may be identified and converted in operation S41. For example, sample input x corresponding to the lower limit of the input range of the nonlinear function may be first identified, and then sample input x corresponding to Xᵢₙₜ+1 may be identified in the next iteration. Xᵢₙₜ+1 may refer to a minimum increase as addition of the least significant bit (LSB) in floating point format. In some embodiments, a number greater than 1 may be added to reduce the number of samples. The nonlinear function may have an input range. For example, the activation function of the artificial neural network may be nonlinear, finite, and continuous. In some embodiments, the input range may correspond to a range of interest of the activation function, and may be defined, for example, as a range in which the activation function is not saturated. The identified sample input may be converted. As described above with reference to the drawings, the nonlinear function may be shifted so that the shortest segment includes zero in floating point format. Accordingly, the sample input x may also be shifted by the constant x_{c}, and the converted sample input t may be x-X_{c}.

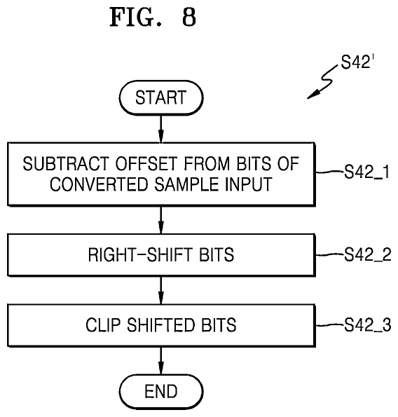

In operation S42, a segment including a sample input may be identified. For example, the index i of the segment including the converted sample input t may be generated by Equation 2 or Equation 3. An example of operation S42 is described below with reference to FIG. 8.

In operation S43, an output of a nonlinear function may be calculated. For example, output y of the nonlinear function f(x) corresponding to the sample input x may be calculated. The sample input x and the output y may be grouped together with the index i identified in operation S42. For example, p, q, r, and s of Equation 6 may be updated as shown in Equation 7 below in operation S43.

$$\begin{matrix}M [ i ] += 1 s [ i ] += xyp [ i ] += x \\ q [ i ] += {x}^{2} \\ r [ i ] += y\end{matrix} \qquad [ Equation 7 ]$$

In Equation 7, M [i] represents the number of sample inputs of the i^{th} segment, and p [i], q [i], r [i], and s [i] represent p, q, r, and s of Equation 6 corresponding to the i^{th} segment, respectively.

In operation S44, it may be determined whether the sample input is a maximum value. As described above, the nonlinear function may have an input range, and when the sample input is initialized to the lower limit of the input range, the maximum value may correspond to the upper limit of the input range. As shown in FIG. 7, when the sample input is not the maximum value, operations S41 to S43 may be subsequently performed, whereas when the sample input is the maximum value, operation S45 may be subsequently performed.

In operation S45, a linear function corresponding to the segment may be derived. For example, M [i], p [i], q [i], r [i], and s [i] of the i^{th} segment may be finally generated by repeatedly performing operations S41 to S43, and the coefficients aᵢ and bᵢ of the linear function from M [i], p [i], q [i], r [i], and s [i] may be calculated based on Equation 6. As a result, N linear functions corresponding to the N segments, respectively, may be derived.

In operation S46, at least one coefficient of the linear function may be added to the lookup table. For example, the coefficients aᵢ and bᵢ corresponding to the i^{th} segment may be added to the index i of the lookup table. As described above with reference to FIG. 1, the lookup table may be referred to by the output generation 13 of FIG. 1.

In some embodiments, different lookup tables may be used depending on the sign of the converted input. For example, when the sample input x is less than the constant x_{c}, the converted sample input t may correspond to x_{c}-x to be positive, and the coefficients of the linear function calculated in operation S45 may be stored in a separate lookup table. In some embodiments, as described below with reference to FIG. 14, different lookup tables may be concatenated and accessed by selectively adding an offset OFF to the index.

FIG. 8 is a flowchart of a method of approximating a nonlinear function according to an embodiment. For example, the flowchart of FIG. 8 shows an example of operation S42 in FIG. 7. As described above with reference to FIG. 7, the segment including the sample input may be identified in operation S42′ of FIG. 8. As shown in FIG. 8, the operation S42′ may include a plurality of operations S42_1 to S42_3.

Referring to FIG. 8, an offset may be subtracted from bits of the converted sample input in operation S42_1, and the subtracted bits may be right-shifted in operation S42_2. For example, as in Equation 2, the offset iₒ may be subtracted from the bits tᵢₙₜ of the converted sample input t, and then the subtracted bits may be right-shifted by the shift amount sh.

In operation S42_3, the shifted bits may be clipped. For example, as in Equation 3, when the bits shifted in operation S42_2 are zero or a positive integer, the shifted bits may be determined to be a segment index, while when the shifted bits are a negative integer, the segment index may be determined to be zero.

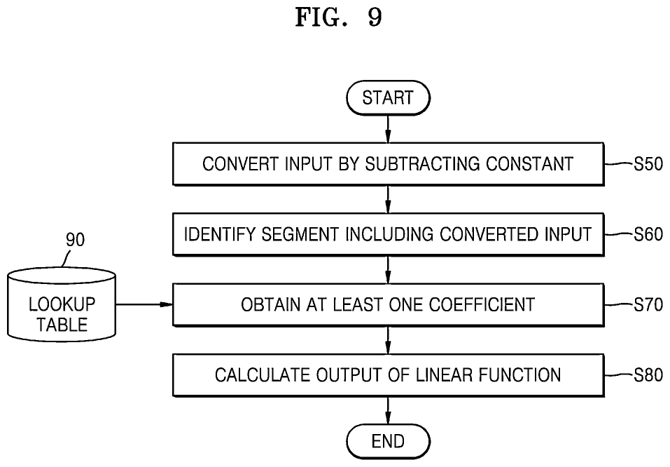

FIG. 9 is a flowchart of a method of approximating a nonlinear function according to an embodiment. For example, the flowchart of FIG. 9 may represent an operation corresponding to the output generation 13 of FIG. 1, and the method of FIG. 9 may be referred to as a method of generating an output of a function approximated in units of a plurality of segments. As described above with reference to FIG. 1, the method of FIG. 9 may be performed online. In some embodiments, the method of FIG. 9 may be performed by the computing device (e.g., computing device 160 of FIG. 16). As shown in FIG. 9, the method of generating the output of the function approximated in units of a plurality of segments may include a plurality of operations S50, S60, S70, and S80.

Referring to FIG. 9, the input may be converted by subtracting a constant in operation S50. As described above with reference to the drawings, a nonlinear function may be shifted and then segmented into a plurality of segment. Accordingly, to identify a segment including an input, the input may be converted by subtracting from the input a constant corresponding to the amount by which the nonlinear function is shifted. For example, the converted input t may be generated by subtracting the constant x_{c} from the input x (t=x−x_{c}).

In operation S60, the segment including the converted input may be identified. For example, the offset iₒ and the shift amount sh may be obtained. In some embodiments, the offset iₒ and the shift amount sh may be stored in advance in registers, a memory, and the like as approximation parameters, and may be referenced when output generation is performed. Then, the index of the segment may be identified from the converted input t based on the obtained offset i, and shift amount sh. For example, as in Equation 2, the offset iₒ may be subtracted from the bits tᵢₙₜ of the converted input t, and then the bits may be right-shifted by the shift amount sh. Additionally, as in Equation 3, when the shifted bits are zero or a positive integer, the shifted bits may be determined to be a segment index, while the segment index may be determined to be zero when the shifted bits are a negative integer. The index of the segment corresponding to the input may be generated through a simple operation.

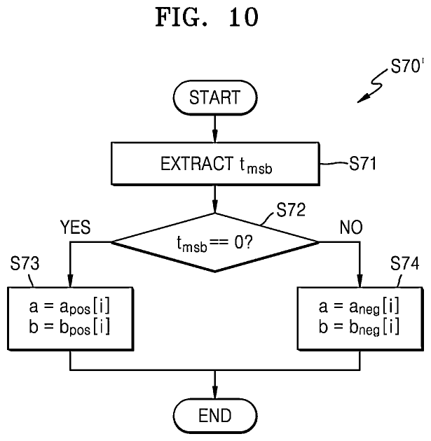

In operation S70, at least one coefficient may be obtained. For example, a lookup table 90 may include coefficients of linear functions that approximate a nonlinear function, as described above with reference to the drawings. At least one coefficient corresponding to the index of the segment identified in operation S60 may be obtained from the lookup table 90. An example of operation S70 is described below with reference to FIG. 10.

In operation S80, the output of the linear function may be calculated. For example, when coefficients a and b are identified in operation S70, the output y corresponding to the input x may be calculated as ax+b.

In some embodiments, when the nonlinear function is symmetric, the method of FIG. 9 may further include preprocessing and post-processing. For example, when the nonlinear function is symmetrical about zero, a section of the nonlinear function corresponding to the positive input may be approximated, and an output corresponding to the negative input may be calculated from an output corresponding to the positive input. To this end, preprocessing may be performed before operation S50 is performed. In the preprocessing, the sign of the input may be identified, and operations S50, S60, S70, S80 may be performed on an absolute value of the input. Additionally, the post-processing may be performed after operation S80 is performed, and when the sign of the input identified in the preprocessing is negative, an output may be generated from a value calculated in operation S80. For example, the value calculated in operation S80 may be generated as the output regardless of the sign of the input when the nonlinear function is y-axis symmetric, while the output may be generated by changing the sign of the value calculated in operation S80 when the nonlinear function is origin symmetric and the sign of the input is negative.

In some embodiments, when the input is outside the input range of the nonlinear function, operations S50, S60, S70, and S80 of FIG. 9 may be omitted. For example, before operation S50 is performed, the input may be compared to each of the upper and lower limits of the input range. When the input is lower than the lower limit, a predefined value, for example, a first saturated value of the nonlinear function, may be generated as the output, and operations S50 to S80 may be omitted. Additionally, when the input is lower than the upper limit, a predefined value, for example, a second saturated value of the nonlinear function, may be generated as the output, and operations S50 to S80 may be omitted.

FIG. 10 is a flowchart of a method of approximating a nonlinear function according to an embodiment. For example, the flowchart of FIG. 10 shows an example of operation S70 in FIG. 9. As described above with reference to FIG. 9, at least one coefficient may be obtained in operation S70′ of FIG. 10. As shown in FIG. 10, the operation S70′ may include a plurality of operations S71 to S74.

Referring to FIG. 10, MSB t_{msb} of the converted input t may be extracted in operation S71. For example, different lookup tables may be used depending on the sign of the converted input t, and the MSB t_{msb} may be extracted to identify the sign of the converted input t. In this case, in operation S60 of FIG. 9, the absolute value of the converted input t may be used to identify the segment, that is, to generate the index i of the segment.

In operation S72, it may be determined whether the MSB t_{msb} is zero. As shown in FIG. 10, when the MSB t_{msb} is zero, that is, when the converted input t is zero or positive, operation S73 may be performed subsequently. On the other hand, when the MSB t_{msb} is 1, that is, when the converted input t is negative, operation S74 may be performed subsequently.

When the MSB t_{msb} is zero, the coefficient a may be obtained from array aₚₒₛ, and the coefficient b may be obtained from array bₚₒₛ in operation S73. On the other hand, when the MSB t_{msb} is not zero, the coefficient a may be obtained from array a_{neg} and the coefficient b may be obtained from array b_{neg} in operation S74. The arrays aₚₒₛ and bₚₒₛ may correspond to the lookup table used when the converted input t is zero or positive, and arrays a_{neg} and b_{neg} may correspond to the lookup table used when the converted input t is negative.

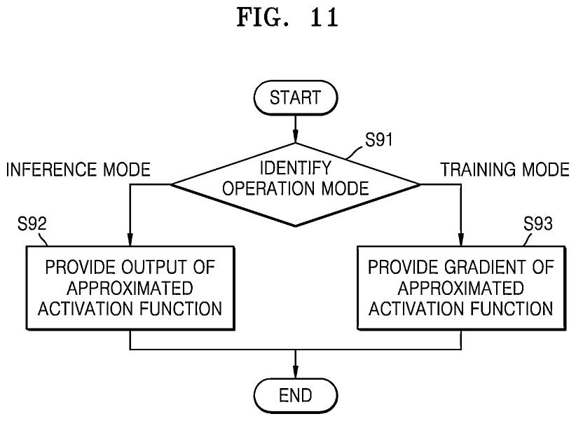

FIG. 11 is a flowchart of a method of approximating a nonlinear function according to an embodiment. For example, the flowchart of FIG. 11 shows a method of using the activation function of the artificial neural network as an approximated function. As shown in FIG. 11, the method of using the approximated activation function may include a plurality of operations S91 to S93. As described below, the approximated activation function may be used for training as well as inference of the artificial neural network.

Referring to FIG. 11, an operation mode may be identified in operation S91. The artificial neural network may be set to an inference mode or a training mode. The artificial neural network may generate an output corresponding to the input based on a state trained in the inference mode, while updating internal parameters in the training mode. As shown in FIG. 11, operation S92 may be performed subsequently when the operation mode is the inference mode, while operation S93 may be performed subsequently when the operation mode is the training mode.

In operation S92, the output of the approximated activation function may be provided. For example, as described above with reference to the drawings, the activation function as a nonlinear function may be approximated in units of a plurality of segments, and an output of the approximated function corresponding to the input may be generated. The output of the approximated activation function may be provided to the next layer of the artificial neural network.

In operation S93, a gradient of the approximated activation function may be provided. The gradient of the activation function may be used in training the artificial neural network such as back propagation. As described above with reference to the drawings, the activation function may be approximated into a linear function in units of a plurality of segments, and the lookup table may include gradients of the linear functions. Accordingly, the gradient of the activation function may be simply obtained from the lookup table, and the training of the artificial neural network may be easily performed. As a result, the training of the artificial neural network may be possible even with limited resources such as mobile systems.

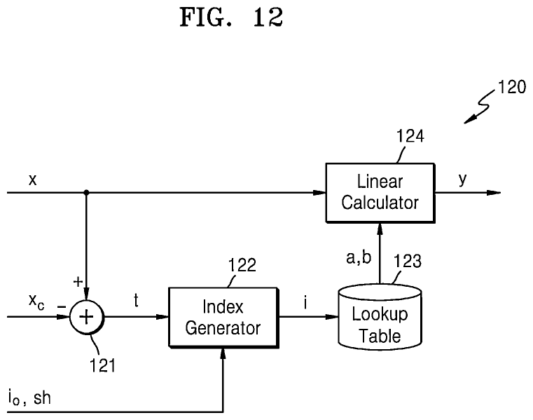

FIG. 12 is a block diagram of an apparatus 120 according to an embodiment. For example, the apparatus 120 may perform the method of FIG. 9. That is, the apparatus 120 may generate the output y of the approximated function from the input x. As shown in FIG. 12, the apparatus 120 may include an adder 121, an index generator 122, a lookup table 123, and a linear calculator 124. In some embodiments, the adder 121, the index generator 122, and the linear calculator 124 may each include logic circuitry. In some embodiments, the lookup table 123 may be stored in memory and/or registers.

The adder 121 may subtract the constant x_{c} from input x. The input x and the constant x_{c} may have a floating point format, and thus, the adder 121 may be referred to as a floating point adder. As described above with reference to the drawings, the constant x_{c} may correspond to the amount by which the nonlinear function is shifted such that the shortest segment of the nonlinear function includes zero in floating point format. The output of the adder 121 may be referred to as converted input t.

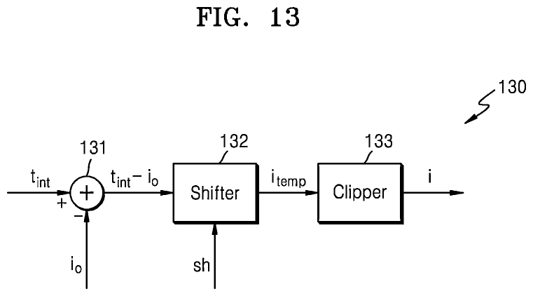

The index generator 122 may generate index i of a segment including the converted input t among a plurality of segments based on at least one bit of the converted input t. For example, as shown in FIG. 12, the index generator 122 may receive the offset iₒ and the shift amount sh and generate the index i based on the offset iₒ and the shift amount sh from the converted input t. An example of the index generator 122 is described below with reference to FIG. 13.

The linear calculator 124 may obtain the coefficients a and b of the linear function from the lookup table 123 based on the index i and calculate the output y based on the input x and the coefficients a and b. The linear calculator 124 may have a structure for performing multiplication and addition of floating-point numbers.

FIG. 13 is a block diagram of an index generator 130 according to an embodiment. For example, the index generator 130 of FIG. 13 may be an example of the index generator 122 of FIG. 12. As described above with reference to FIG. 12, the index generator 130 of FIG. 13 may generate the index i of the segment based on the offset iₒ and the shift amount sh from the converted input t. As shown in FIG. 13, the index generator 130 may include an adder 131, a shifter 132, and a clipper 133. In some embodiments, each of the adder 131, the shifter 132, and the clipper 133 may include logic circuitry.

Referring to FIG. 13, the adder 131 may subtract the offset iₒ from the converted bits tᵢₙₜ of the input t. In the adder 131, the converted bits tᵢₙₜ and offset iₒ of the input t may have an integer form, and accordingly, the adder 131 may be referred to as an integer adder. As shown in FIG. 13, the adder 131 may output tᵢₙₜ-iₒ.

The shifter 132 may right-shift the output of the adder 131. For example, as shown in FIG. 13, the shifter 132 may receive the shift amount sh, and the output of the adder 131 may be rig-shifted by the shift amount sh. As shown in FIG. 13, the output of the shifter 132 may be referred to as a temporary index iₜₑₘₚ.

The clipper 133 may generate the index i by clipping the temporary index iₜₑₘₚ. For example, when the temporary index iₜₑₘₚ is negative, the clipper 133 may generate the index i which is zero. Each of the adder 131, the shifter 132, and the clipper 133 may be implemented as simple logic circuitry, and the index generator 130 may generate the index i at high speed.

FIG. 14 is a diagram of a lookup table 140 according to an embodiment. As described above with reference to the drawings, the lookup table 140 may include coefficients of linear functions respectively corresponding to segments of the nonlinear function.

In some embodiments, the lookup table 140 may include a portion corresponding to input x greater than or equal to the constant x_{c} and a portion corresponding to input x less than the constant x_{c}. For example, as shown in FIG. 14, the lookup table 140 may include a first portion 141 including coefficients corresponding to the input x greater than or equal to the constant x_{c} and a second portion 142 including coefficients corresponding to the input x less than the constant x_{c}. As shown in FIG. 14, the first portion 141 may correspond to the lookup table index iₗₒₒₖᵤₚ from 0 to OFF-1, and the second portion 142 may correspond to the lookup table index iₗₒₒₖᵤₚ from OFF (OFF is a positive integer).

The index generator 122 of FIG. 12 may access the lookup table 140 by selectively adding the offset OFF to the index i according to the sign of the converted input t. For example, the index generator 122 may extract the MSB t_{msb} of the converted input t. When the MSB t_{msb} is zero, that is, when the converted input t is zero or positive, the index generator 122 may output the index i as the lookup table index iₗₒₒₖᵤₚ. On the other hand, when MSB t_{msb} is 1, that is, when the converted input t is negative, the index generator 122 may output the lookup table index iₗₒₒₖᵤₚ by summing the index i and the offset OFF.

FIG. 15 is a block diagram of a computing system 150 according to an embodiment. In some embodiments, the segmentation 11 and/or approximation 12 of FIG. 1 may be performed by the computing system 150 of FIG. 15. As shown in FIG. 15, the computing system 150 may include system memory 151, at least one processor 152, storage 153, input/output devices 154, and communication connections 155. The components included in the computing system 150 may be communicatively connected to each other through, for example, a bus.

The system memory 151 may store a program PGM. The program PGM may cause at least one processor 152 to perform the method of approximating the nonlinear function described above with reference to the drawings. For example, the program PGM may include a series of instructions executable by the at least one processor 152, and the series of instructions included in the program PGM may be executed by the at least one processor 152 to approximate the nonlinear function. As a non-limiting example, the system memory 151 may include volatile memory such as static random access memory (SRAM) and dynamic random access memory (DRAM), or may include non-volatile memory such as flash memory.

The at least one processor 152 may include at least one core capable of executing any instruction set (e.g., IA-32, 64-bit extension IA-32, x86-64, PowerPC, Spark, MIPS, ARM, IA-64, etc.). The at least one processor 152 may execute instructions stored in the system memory 151 and may perform approximation of the nonlinear function by executing the program PGM.

The storage 153 may not lose stored data even when power supplied to the computing system 150 is cut off. For example, the storage 153 may include non-volatile memory such as electrically erasable programmable read-only memory (EEPROM), flash memory, phase change random access memory (PRAM), resistance random access memory (RRAM), nano floating gate memory (NFGM), polymer random access memory (PoRAM), magnetic random access memory (MRAM), ferroelectric random access memory (FRAM), and the like, or may include a storage medium such as a magnetic tape, an optical disk, or a magnetic disk. In some embodiments, the storage 153 may be detachable from the computing system 150.

In some embodiments, the storage 153 may store the program PGM for approximating the nonlinear function described above with reference to the drawings, and the program PGM or at least a part thereof may be loaded from the storage 153 into the system memory 151 before the program PGM is executed by the at least one processor 152. In some embodiments, the storage 153 may store a file created in a program language, and the program PGM generated by a compiler or the like may be loaded from the file into the system memory 151.

In some embodiments, the storage 153 may store data to be processed by the at least one processor 152 and/or data processed by the at least one processor 152. For example, the storage 153 may store a lookup table and store approximation parameters such as constant x_{c}, offset iₒ, and/or shift amount sh.

The input/output devices 154 may include an input device such as a keyboard, a pointing device, or the like, and may include an output device such as a display device, a printer, or the like. For example, through the input/output devices 154, a user may trigger execution of the program PGM by the at least one processor 152, may input the approximation parameters, or may check the coefficients included in the lookup table.

The communication connections 155 may provide access to a network external to the computing system 150. For example, the network may include multiple computing systems and communication links, wherein the communication links may include wired links, optical links, wireless links, or any other type of links.

FIG. 16 is a block diagram of a computing device 160 according to an embodiment. In some embodiments, the output generation 13 of FIG. 1 may be performed by the computing device 160 of FIG. 16. The computing device 160 may be a portable computing device powered by a battery or self-generated power, such as a mobile phone, a tablet PC, a wearable device, an Internet of Things device, etc., or may be a stationary computing device, such as a desktop PC, a server, etc.

As shown in FIG. 16, the computing device 160 may include a memory subsystem 161, input/output devices 162, a processing unit 163, and a network interface 164, wherein the memory subsystem 161, the input/output devices 162, the processing unit 163, and the network interface 164 may communicate with each other through a bus 165. In some embodiments, at least two from among the memory subsystem 161, the input/output devices 162, the processing unit 163, and the network interface 164 may be included in one package as a system-on-a-chip (SoC).

The memory subsystem 161 may include RAM 161_1 and storage 161_2. The RAM 161_1 and/or the storage 161_2 may store instructions executed and data processed by the processing unit 163. For example, the RAM 161_1 and/or the storage 161_2 may store variables such as signals, weights, and biases of the artificial neural network, and may store parameters of an artificial neuron (or computational node) of the artificial neural network. In some embodiments, the storage 161_2 may include non-volatile memory.

The processing unit 163 may include a central processing unit (CPU) 161_1, a graphics processing unit (GPU) 163_2, a digital signal processor (DSP) 163_3, and a neural processing unit (NPU) 163_4. In some embodiments, the processing unit 163 may include only a part of the CPU 163_1, the GPU 163_2, the DSP 163_3, and the NPU 163_4.

The CPU 163_1 directly performs the overall operation of the computing device 160, for example, a specific task in response to external input received through the input/output devices 162, or may instruct other components of the processing unit 163 to perform operations. The GPU 163_2 may generate data for an image output through a display device included in the input/output devices 162, or may encode data received from a camera included in the input/output devices 162. The DSP 163_3 may generate useful data by processing digital signals, such as digital signals provided from the network interface 164.

The NPU 163_4 as dedicated hardware for the artificial neural network may include a plurality of calculation nodes corresponding to at least some artificial neurons constituting the artificial neural network, and at least some of the plurality of calculation nodes may process signals in parallel. As described above with reference to the drawings, the approximated activation function may be implemented with high accuracy and low cost. Accordingly, the artificial neural network, such as a deep neural network, may be easily implemented in the computing device 160 and may have a high processing speed, and may be implemented by, for example, a simple and small-scale NPU 163_4.

The input/output devices 162 may include input devices such as a touch input device, a sound input device, a camera, and the like, and output devices such as a display device, a sound output device, and the like. For example, when the user's voice is input through the sound input device, the voice may be recognized by the deep neural network implemented in the computing device 160, and an action may be triggered accordingly. In addition, when the image is input through the camera, objects included in the image may be recognized by the deep neural network implemented in the computing device 160, and an output such as virtual reality may be provided to the user. The network interface 164 may provide access to a mobile communication network such as long term evolution (LTE), 5G, or the like to the computing device 160, or may provide access to a local network such as Wi-Fi.

While non-limiting example embodiments of the present disclosure have been particularly shown and described, it will be understood that various changes in form and details may be made therein without departing from the spirit and scope of the present disclosure.

What is claimed is:

1. A method of approximating a nonlinear function in units of a plurality of segments, the method comprising:
detecting an input included in a shortest segment among the plurality of segments;
shifting the nonlinear function such that the input is zero in a floating point format;
defining the plurality of segments based on at least one bit of the floating point format; and
approximating the plurality of segments into a plurality of linear functions, respectively.

2. The method of claim 1, wherein the detecting the input comprises:
calculating a curvature of the nonlinear function; and
determining the input, wherein the input corresponds to a maximum curvature point of the curvature.

3. The method of claim 1, wherein the detecting the input comprises determining the input for which an output of the nonlinear function is zero.

4. The method of claim 1, wherein the approximating the plurality of segments comprises:
identifying and converting a sample input in the floating point format in an input range of the nonlinear function;
identifying a segment including the sample input;
calculating an output of the nonlinear function corresponding to the sample input;
deriving, based on a plurality of sample inputs included in one segment and a plurality of outputs respectively corresponding to the plurality of sample inputs, a linear function corresponding to the one segment; and
adding at least one coefficient of the linear function to a lookup table.

5. The method of claim 4, wherein the identifying the segment comprises extracting an index of the segment by obtaining a value by subtracting an offset from bits of the converted sample input and then right-shifting the value.

6. The method of claim 5, wherein the extracting the index comprises determining that the index is zero based on the value, after being right-shifted, being a negative integer.

7. The method of claim 5, wherein the defining the plurality of segments comprises obtaining the offset and an amount of the right-shifting.

8. The method of claim 1, wherein the nonlinear function includes an activation function of an artificial neural network.

9. An apparatus comprising:
a memory that stores a series of instructions; and
at least one processor configured to perform the method of claim 1 by executing the series of instructions.

10. A method of generating an output of a nonlinear function approximated in units of a plurality of segments, the method comprising:
generating a converted input by subtracting a constant from an input in a floating point format;
identifying a segment, including the converted input, among the plurality of segments based on at least one bit of the converted input;
obtaining at least one coefficient of a linear function corresponding to the segment, that is identified, from a lookup table; and
calculating the output of the linear function based on the converted input and the at least one coefficient,
wherein the constant corresponds to an amount by which the nonlinear function is shifted so that a shortest segment among the plurality of segments includes zero in the floating point format.

11. The method of claim 10, wherein the identifying the segment comprises:
obtaining an offset and a shift amount; and
extracting an index of the identified segment by obtaining a value by subtracting the offset from bits of the converted input and then right-shifting the value by the shift amount.

12. The method of claim 11, wherein the extracting the index comprises determining that the index is zero based on the value, after being right-shifted, being a negative integer.

13. The method of claim 11, wherein the obtaining the at least one coefficient comprises:
identifying a sign of the converted input; and
generating an index of the lookup table based on the index of the identified segment and the sign.

14. The method of claim 10, wherein the nonlinear function includes an activation function of an artificial neural network.

15. The method of claim 14, further comprising:
providing the output in an inference mode of the artificial neural network; and
providing the at least one coefficient in a training mode of the artificial neural network.

16. An apparatus comprising:
a memory that stores a series of instructions; and
at least one processor configured to perform the method of claim 10 by executing the series of instructions.

17. An apparatus for generating an output of a nonlinear function approximated in units of a plurality of segments, the apparatus comprising:
a floating point adder configured to generate a converted input by subtracting a constant from an input in a floating point format;
an index generator configured to generate an index of a segment, including the converted input, among the plurality of segments based on at least one bit of the converted input; and
a linear calculator configured to obtain at least one coefficient of a linear function based on the index from a lookup table and generate the output based on the input and the at least one coefficient,
wherein the constant corresponds to an amount by which the nonlinear function is shifted so that a shortest segment among the plurality of segments includes zero in the floating point format.

18. The apparatus of claim 17, wherein the index generator comprises:
an integer adder configured to subtract an offset from bits of the converted input; and
a shifter configured to right-shift an output of the integer adder.

19. The apparatus of claim 18, wherein the index generator further comprises a clipper configured to output an output of the shifter as the index based on the output of the shifter being zero or a positive integer, and output the index as zero based on the output of the shifter being a negative integer.

20. The apparatus of claim 17, wherein the nonlinear function comprises an activation function of an artificial neural network.
